(19) United States
(12) Patent Application Publication
(10) Pub. No.: US 2002/0190921 A1
(43) Pub. Date: Dec. 19, 2002

(54) Three-dimensional display

(76) Inventor: Ken Hilton, Reedsburg, WI (US)

Correspondence Address: KENYON & KENYON, ONE BROADWAY, NEW YORK, NY, 10004, US

(21) Appl. No.: 09/883,447

(22) Filed: Jun. 18, 2001

(51) Int. Cl. G09G 5/00

(52) U.S. Cl. 345/6

(57) ABSTRACT

A three-dimensional display is disclosed that includes a plurality of light-emitting elements, the light-emitting elements arranged in a three-dimensional pattern, each light-emitting element having a plurality of display settings. The three-dimensional display also includes a plurality of display planes, each display plane including a mutually exclusive subset of the plurality of the light-emitting elements, the subsets of respective display planes being mutually exclusive. The three-dimensional display also include a controller, the controller configured to receive an external signal and to generate an internal signal for controlling the display settings of at least one of the plurality of light-emitting elements as a function of the external signal.

### BACKGROUND INFORMATION

Most previous work on data displays involves two-dimensional displays, such as cathode ray tubes. Holography, three-dimensional display glasses, and other known methods may allow data to be viewed as if it were three-dimensional by tricking the eye. The users of such devices may also be required to employ special viewing equipment. The images displayed by such devices may not be viewable from all angles. For example, Berlin (U.S. Pat. No. 4,160,973) displays a three dimensional image by moving a two dimensional display through a space at a rate sufficient to trick the eye into seeing a three-dimensional image. No persistent three-dimensional image is ever displayed. Other methods based on holography, stereography, or other similar methods also do not produce a true three-dimensional representation of the information to be displayed.

In contrast, a true three-dimensional display of an image allows it to be viewed from all angles, as it actually would be seen. Fryklund (U.S. Pat. No. 2,762,031) discusses a system with planes of electrodes arranged inside a glow discharge tube filled with an ionizable gas. Although three-dimensional images displayed in Fryklund's device may persist if an appropriate phosphor is employed, Fryklund does not produce an image that can displayed indefinitely without being refreshed by a new signal.

The advantages of a true three-dimensional display of data were recognized in MacFarlane (U.S. Pat. No. 5,801,666). MacFarlane discusses a three-dimensional display using optically active elements or “voxels”. However, MacFarlane's device is monolithic, requiring the fabrication of a single device using special optical materials. Substructures of MacFarlane's display are not replaceable or removable, and no control logic or capability that allows the exploitation of a three-dimensional media is discussed.

### BRIEF DESCRIPTION OF THE DRAWINGS

FIG. 1 illustrates an example three-dimensional display, according to an example embodiment of the present invention.

FIG. 2 illustrates the logical relationship of the major components of the example three-dimensional display illustrated in FIG. 1, according to an example embodiment of the present invention.

FIG. 3 illustrates an example system chassis in an example three-dimensional display, according to an example embodiment of the present invention.

FIG. 4 illustrates an example system interface board in an example three-dimensional display, according to an example embodiment of the present invention.

FIG. 5 illustrates an example external interface for the example three-dimensional display illustrated in FIG. 1, according to an example embodiment of the present invention.

FIG. 6 illustrates an example display plane in the example three-dimensional display illustrated in FIG. 1, according to an example embodiment of the present invention.

FIG. 7 illustrates a logical block diagram of the example display plane illustrated in FIG. 6, according to an example embodiment of the present invention.

### DETAILED DESCRIPTION

In an example embodiment according to the present invention, an example three-dimensional display may include light-emitting elements, e.g., light-emitting diodes, which may be deployed in a three-dimensional array. Coded external signals may be received by the example three-dimensional display. The coded external signals may be communicated to the three-dimensional display over a network, from a computer, or directly from a user interface. The coded external signals may be received by a controller. Based on these coded signals, the controller may generate internal signals to control the light-emitting elements. Different internal signals may result in different configurations of light-emitting elements being activated or de-activated. The example three-dimensional display may be configured so that selected light-emitting elements remain lit until a signal is received to deactivate them, or until the system is reset.

Example System Configuration

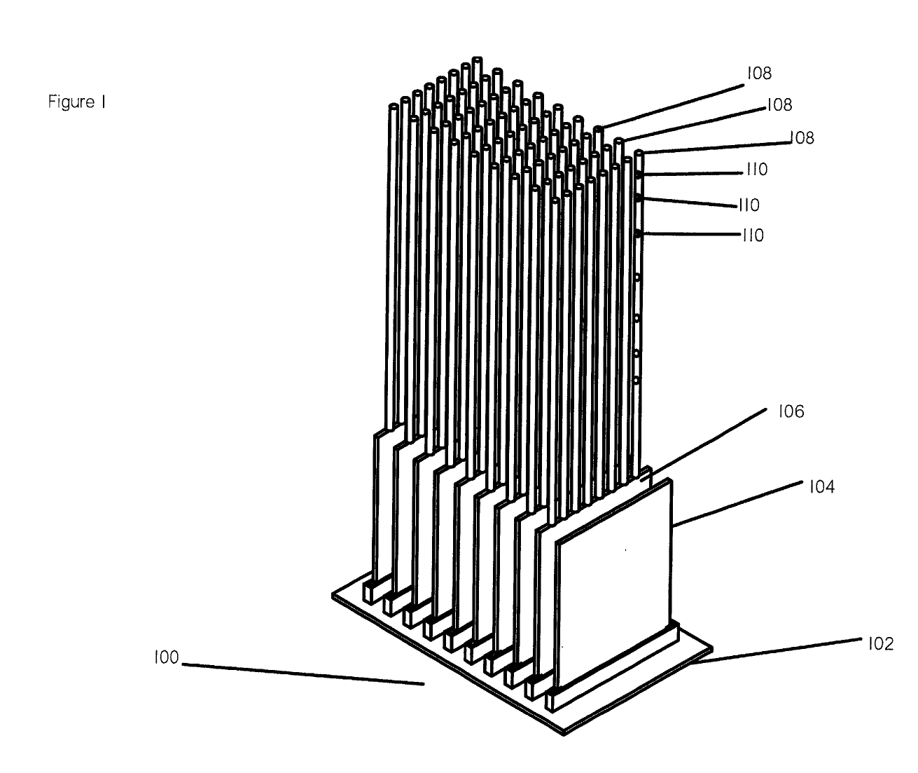

FIG. 1 illustrates a three-quarter view of an example three-dimensional display 100, according to an example embodiment of the present invention.

The example three-dimensional display 100 may include a chassis 102. The chassis 102 may provide a physical base for the example three-dimensional display 100. The chassis 102 may allow the mounting of other components of the three-dimensional display 100. The chassis 102 may also provide data, control, and power and ground interconnection for the other components of the three-dimensional display.

The example three-dimensional display 100 may include a system control board 104. The system control board 104 may serve as a controller for the three-dimensional display. The system control board 104 may receive signals from outside the three-dimensional display, and transmit internal control signals to other components of the three-dimensional display 100.

The example three-dimensional display 100 may include display planes 106. Each display plane 106 may contain a subset of the light-emitting elements in the three-dimensional display 100. Each display plane 106 may include one or more mounting elements 108. The mounting elements may be attached to a circuit card that controls the display plane's subset of light-emitting elements in the three-dimensional display and interfaces with the system controller board of the three-dimensional display via the chassis. In the illustrated example three-dimensional display these mounting elements may be transparent plastic columns. Light-emitting elements 110 may be mounted in or attached to each mounting element. The illustrated example three-dimensional display may include 9 display planes 106, each display plane having eight mounting elements 108, and each mounting element 108 including eight light-emitting elements 110, for a total of 576 light-emitting elements. It will be appreciated that the number of display planes, the type and number of mounting elements, and the type and number of light-emitting elements may be varied. It will also be appreciated that other configurations of elements may also be provided.

In the example three-dimensional display 100, the set of light-emitting elements 110 in a display plane may form both a physical and a logical subset of the set of light-emitting elements. However, it will be appreciated that other arrangements of the light-emitting elements 110 may be provided, e.g., logical (control) subsets of the light-emitting elements 110 might not use the same division of the light-emitting elements 110 as the physical division of the elements 110 into display planes 106.

Each light-emitting element 110 in the example three-dimensional display 100 may have both an “on” and “off” state. It will be appreciated that light-emitting elements with additional states, for example with varying brightness or colors could be provided, but additional information may need to be transmitted as an internal control signal in order to control the state of a variable brightness or colored light-emitting element.

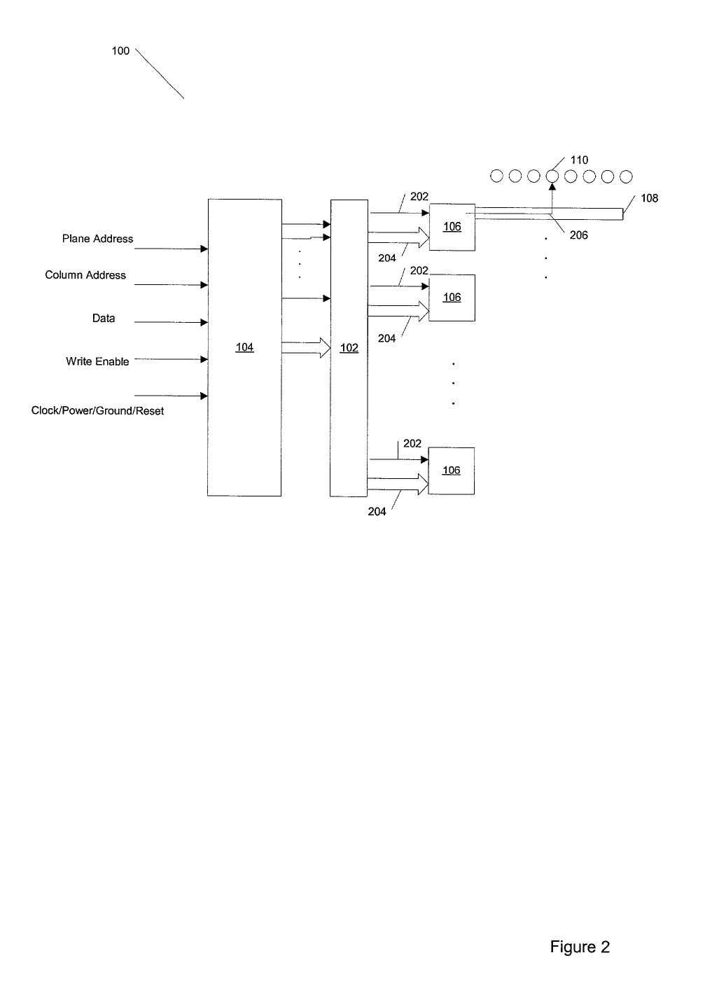

FIG. 2 illustrates a functional block diagram of an example three-dimensional display 100, according to an example embodiment of the present invention.

The three-dimensional display 100 may receive external signals, e.g., via an external interface that is part of the system control board 104. The received signals may include information for display, as well as clock, power, and ground. Received information for display may include both coded address and display data signals. The display data may indicate the settings, e.g., “on” or “off”, for a subset of the light-emitting elements in the three-dimensional display, e.g., the light-emitting elements in one column of one display plane.

The received address information may include both a plane address and a column address. The plane address may be used to identify the display plane for which the received display data is intended. The column address may be used to identify the column in the selected display plane for which the received data is intended. For example, 4 input address lines may be used to select one of the 9 display planes. Three input address lines may be used to indicate one of the eight columns on the selected display plane. Although address and data signals in the example three-dimensional display are received in parallel, it will be appreciated that other mechanisms may be used to communicate the data. For example, the address and data information could be received as data packets or serially, then buffered and interpreted by a microprocessor. The system control board 104 may also receive a write enable signal, clock, power, ground, and system reset signals.

The system control board 104 may process the signals received from outside the three-dimensional display and distribute internal signals via the chassis 102, which may serve as an internal bus. The signals may distribute via the chassis 102 to the display planes 106. The same set of address and display data signals 204 may be distributed to all of the display planes.

The system control board may decode the received plane address signal and generate a plane select signal 202 for the appropriate plane. The selected display plane 106 may, upon receiving its plane select signal 202, read and process the address and display data 204. The other planes may ignore the received address and display data signals unless the appropriate plane select signal is received. It will be appreciated that other mechanisms for distributing signals to the correct plane may be used, e.g., separate datapaths may be provided to each plane, packet switching with addresses may be employed, etc.

When the selected display plane 106 receives its corresponding plane select signal 202, it may read the address and display data signals 204 from the bus. The display plane may decode the column address included in the signals 204 and generate output signals 206 that are transmitted via one of the supporting elements 108 to the corresponding light-emitting element 10. It will be appreciated that the display plane may provide a latching function that continuously transmits a signal to each light-emitting element in the plane, changing the output signal 206 only when an appropriate signal is received from the system controller 104. The signals 204 may also include a system reset signal, which when received by a display plane 106, may cause the display plane to return all of the light-emitting elements in the display plane to a predefined setting, e.g., turning all elements off.

The architecture of the example system chassis 102, example system controller board 104, and example display planes 106, are described in more detail below.

Example System Chassis

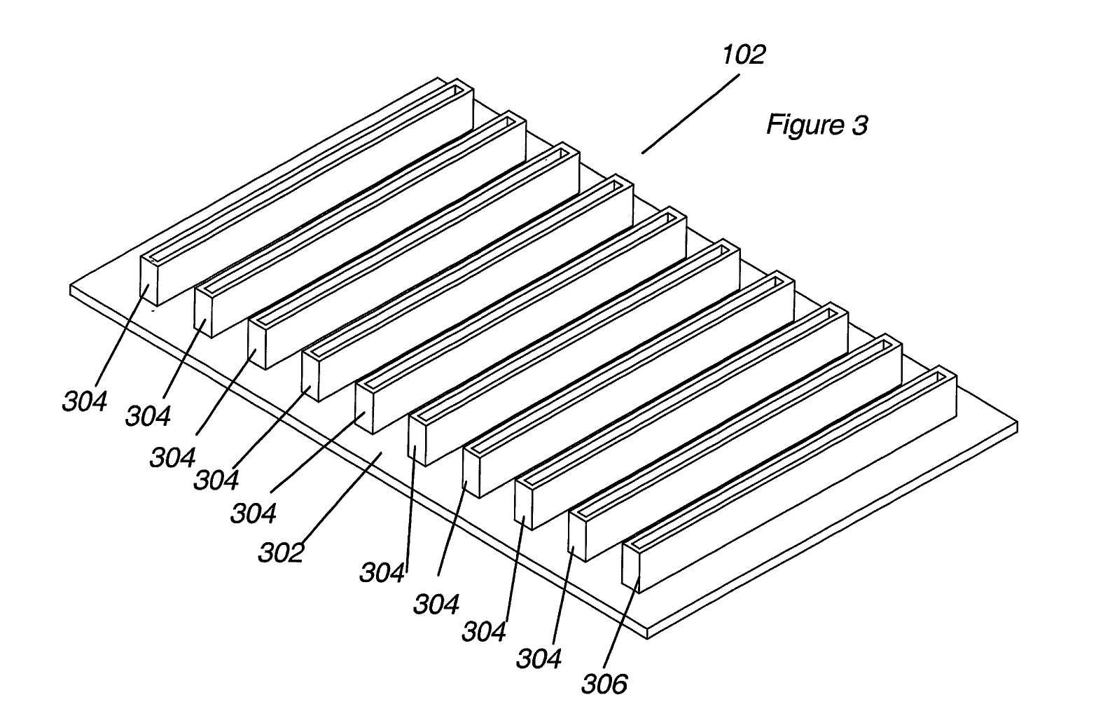

FIG. 3 illustrates an example system chassis 102, according to an example embodiment of the present invention. The chassis may be implemented with a frame 302 made of wood, plastic, or other rigid materials. The frame may contain multiple connector slots 304 that provide physical and logical connection for the display planes. A conventional edge connector may be employed, e.g., a conventional 25 pin female “D” type connector.

The example system chassis 102 may also contain a controller slot 306 for an input board. The controller slot 306 may be the same type of connector as the other connector slots 304. It will be appreciated that, even if the controller slot 306 is the same type of connector as the plane connector slots 304, the controller slot 306 may need to be wired differently than the connector slots 304.

The example system chassis 102 may include wiring or other interconnect that links the connector slots, and distributes signals as well as power and ground to other components of the three-dimensional display. These signals may be distributed to the connectors across a common bus, as long as the individual display plane select signals are received by the corresponding display plane.

Example Controller

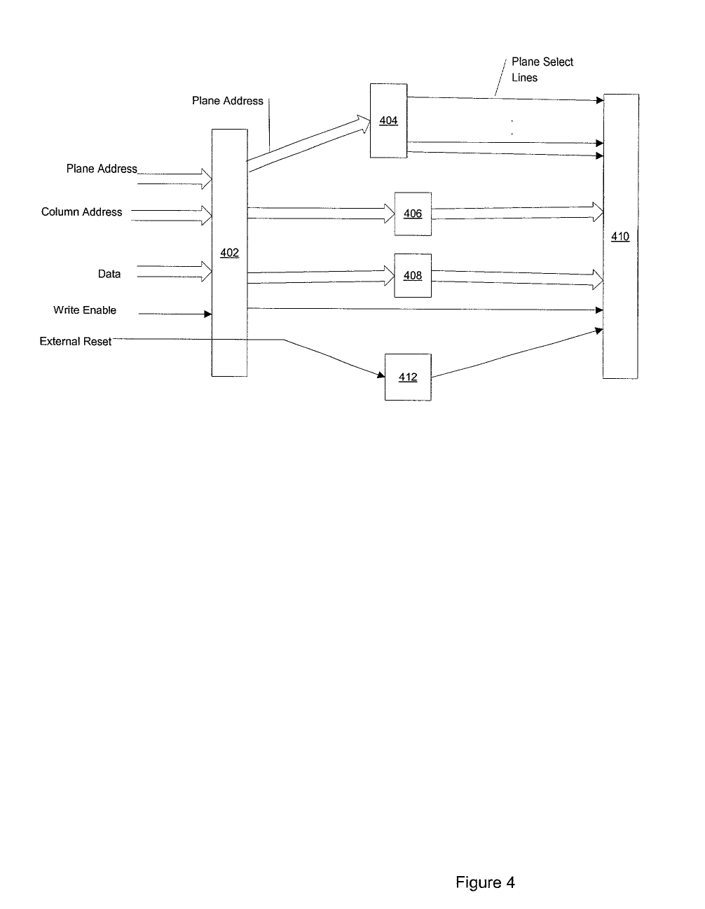

FIG. 4 illustrates an example controller, according to an example embodiment of the present invention. The example controller may be configured to receive external signals from outside the three-dimensional display, to process these signals, and to generate and distribute internal signals to control the operation of light-emitting elements in the display. The example controller may be implemented as a single controller board in the three dimensional display, e.g., system controller board 104 illustrated in FIG. 1. It will be appreciated that the controller may also be implemented with other architectures, e.g., the controller could be included in a display plane, or as part of the chassis.

The example controller may receive signals from outside the three-dimensional display, for example via a digital interface 402. The example controller's digital interface may be provided using a standard 25 pin “D” connector. Signals may be received from a hard-wired dedicated “front end” or from digital sources such as a personal computer via a cable connected to the digital interface 402. The received signals may include data for display, display address information including both the plane address and the column address, read and write enabling signals, and reset signals. It will be appreciated that other signals may also be received by the example controller.

The example controller may include plane select logic mechanism 404. The plane select logic mechanism 404 may be configured to receive a portion of the external signal that indicates the address of the display plane for which the current signal is intended to provide information for display. Based on the received display plane address information, the plane select logic mechanism 404 may signal one of the display planes that is the selected display plane, i.e., that the currently received data is intended for that display plane. For example, each display plane may have a corresponding plane select line. The plane select logic mechanism 404 may drive the line for the selected display plane high, while driving all the other plane select lines low. In the example three-dimensional display, the plane select logic mechanism may be implemented using a standard 74LS154 4:9 select chip. It will be appreciated that other mechanisms may be provided to determine which display planes receive the current input data, e.g., multiple planes may receive the data. Alternatively, the plane select mechanism could generate a special numerical signal that could be recognized by the display plane, or the display planes might be configured to recognize when their address has been received by the three-dimensional display.

The example controller may include an address buffer 406. The address buffer 406 may be configured to receive address signals from the external interface and buffer the address signals for transmission to a display plane. The buffered address signals may include the column address, which is transmitted to the display planes. In the example three-dimensional display the address buffer 406 may be provided using a standard 74LS244 Octal Buffer.

The example controller may include a data buffer 408. The data buffer may be configured to receive data signals from the external interface and buffer the data signals for transmission to a display plane. The buffered data signals may be configured to indicate the states to which the light-emitting elements indicated by the address signals should be set. In the example three-dimensional display the data buffer 408 may be provided using a standard 74LS244 Octal Buffer.

The example controller may include a display interface 410. In the example three-dimensional display this interface may be a standard 44 pin edge connector.

The example controller may include a reset logic mechanism 412. The reset logic mechanism may be configured to receive an external reset signal, and upon receiving the reset signal to reset the three-dimensional display. The reset logic mechanism may be configured to operate asynchronously, i.e., independent of the current state of the clock or write enable signal. In the example three dimensional display, the reset logic mechanism 412 may be provided using a standard power on reset chip, e.g., a standard 555 timer chip.

It will be appreciated that the example controller may include other components and provide other capabilities. For example, the example controller may also include an on-board clock. The on-board clock may be used to provide timing signals for data storage in the display. Memory may be included on the controller board to store pre-stored images. A predefined signal may then be used to indicate that the series of predefined images should be output from the memory.

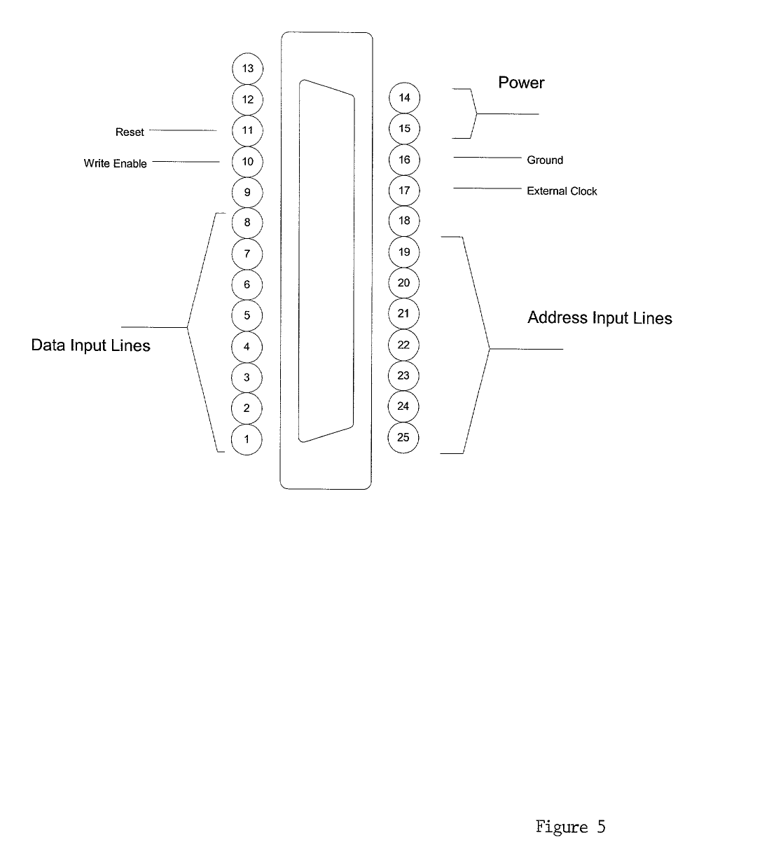

FIG. 5 illustrates an example external interface for the example three-dimensional display, according to an example embodiment of the present invention. The interface may be standard 25 pin female “D” connector located on the controller board.

In the example system interface, the first eight pins may be used for inputting eight bits of display data in parallel. This display data may be used to indicate the desired settings for eight light-emitting elements in a selected column of a selected display plane. The pin denoted 10 in the illustrated example system interface, may be used for a write enable signal. The pin denoted 11 in the illustrated example system interface may be used as a system reset signal. Power, ground, and clock may be provided through the interface, although it will be appreciated that power could also be provided by separate power connections. Seven lines, denoted lines 19-25, may be used to provide address data. The address signal may be used to identify the subset of the light-emitting elements to be set using the current display data signal. Four lines indicating a selected display plane, and three lines indicating a selected column in the display plane. In the example three-dimensional display, individual addressable subsets of light-emitting elements in the display plane may correspond to the individual physical sets of light-emitting elements that are installed in a display plane on transparent rods. However, it will be appreciated that other arrangements may be employed, as long as the light-emitting elements that are to be set can be identified from the received address data.

It will be appreciated that the illustrated pin arrangement is illustrative, but other pin arrangements could be used. Data might be transmitted serially, in addressed packets, or using other conventional mechanisms.

Display Plane

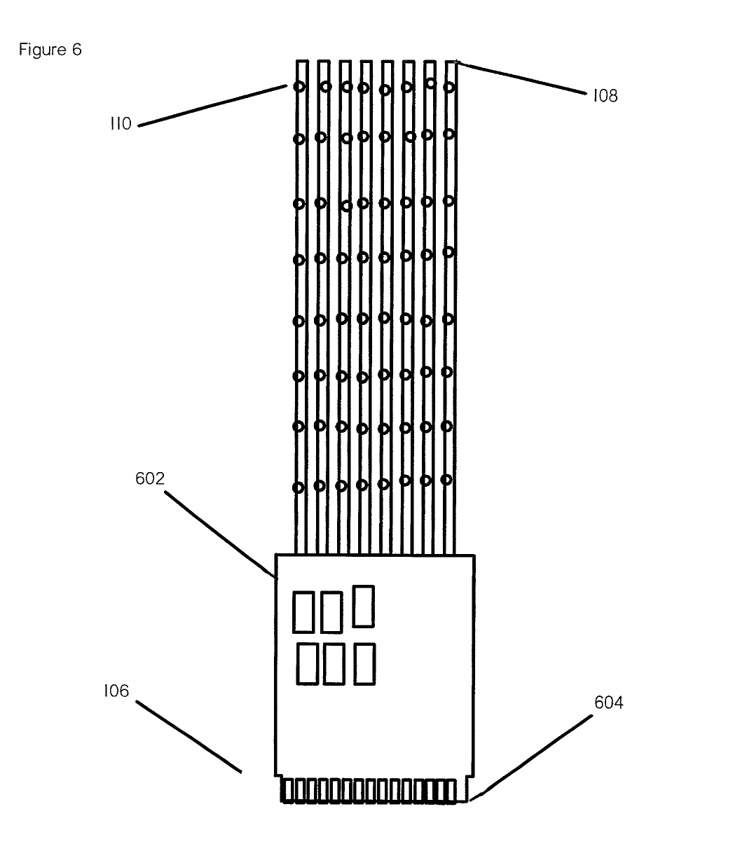

FIG. 6 illustrates an example display plane 106, according to an example embodiment of the present invention. The example display plane 106 is illustrated as a planar structure. The display planes in the example three-dimensional display may be positioned in parallel with each other. It will be appreciated that although the example display plane 106 includes a planar subset of the light-emitting elements in the three-dimensional display, the display plane need not be planar structure, but could include any subset of the three-dimensional display that may be mechanically and electrically coupled as a subunit of the three-dimensional display, e.g., a cubic display of 64 rods and eight planes could instead be divided into four rectangular prisms of 4×4 rods each.

The example display plane 106 may include a display plane controller card 602. The display plane controller card 602 may be a printed circuit board with various electronic devices attached to it. The example display plane may also include an input connector 604, for connecting the display plane controller card 602 to the chassis. The input connector may be used to provide an electrical and logical connection to the rest of the three-dimensional display, e.g., via a system bus, or through the chassis. The input connector 604 may be configured to receive data and control signals for use by the display plane. The input connector may be an edge connector mounted on the edge of the circuit card 602. The edge connector 604 may be used to physically secure the display plane in the chassis. It will be appreciated that other forms of fastening the display plane to the chassis may be employed, e.g., clips, screws, plastic snap-in connectors, etc. In the example display plane with eight columns of eight elements each, a standard edge connector may be used. It will be appreciated that a larger connector may be used for a larger display plane, or alternatively different coding and address schemes may be employed to control a larger display plane with the same number of input pins.

The example display plane may include mounting elements 108. The illustrated example display plane has eight mounting elements 108. It will be appreciated that more or fewer mounting elements may be employed. In the example display plane, these mounting elements may be transparent, hollow plastic rods. The rods may be affixed to the circuit card mechanically or with an adhesive.

In the example display plane, light-emitting elements 110 may be attached to the mounting elements 108, e.g., by adhesively mounting the light-emitting elements 110 inside the hollow, transparent rods. The light-emitting elements 110 may be light-emitting diodes (LEDs), lasers, small light bulbs, or any other suitable light-emitting device. The light-emitting elements 110 may be electrically connected to the display plane controller card 502 via the mounting element 108, e.g., by including fine wires in or on the mounting elements, or alternatively by including conductive elements in the structure of the mounting rod. The wire or other connection may be electrically connected to an output pin on the display controller card 602.

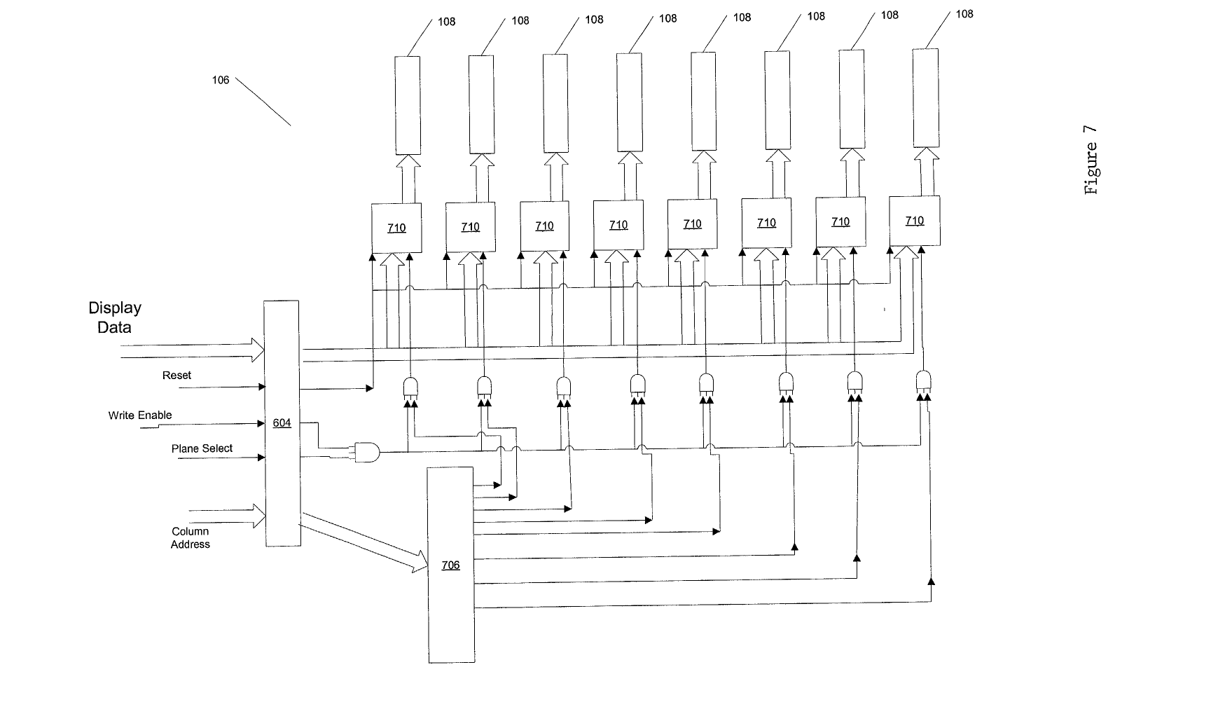

FIG. 7 illustrates a logical block diagram for the example display plane 106, according to an example embodiment of the present invention. The example display plane illustrated in FIG. 7 may include eight columns of eight light-emitting elements, for a total of 64 light-emitting elements. It will be appreciated that the same or similar logical structure may be provided for different numbers of light-emitting elements. It will also be appreciated that other logical structures could be used, e.g., based on serial transmission of data, or using a broader bus transmitting data for the entire display plane in parallel.

The edge connector 604 may be used by the example display plane to receive several types of signals illustrated in FIG. 7, including data for display, a reset signal, a write enable signal, a plane select signal, and a column address for the displayed data.

The display data may be used to indicate desired settings for light-emitting elements contained in the display plane. In the example display plane 106, eight data lines may be used to receive the settings for eight light-emitting elements in one of the columns 108 of the display plane 106.

The display data may be transmitted to a latch mechanism 710, which is associated with one of the columns 108. Each latch mechanism 710 may be associated with a subset of the light-emitting elements in the display plane, e.g., the light-emitting elements on a particular mounting element. Display data from the connector 604 may be transmitted directly to the latch, or alternatively may be buffered in a data buffer, depending on the exact timing/clocking properties of the three-dimensional display.

In the example display plane the latch mechanism 710 may be a standard latch with a reset capability, e.g., a 74LS273 Octal latch with reset capability. However, it will be appreciated that the latch mechanism need not be a discrete latch component, but may be provided as part of some other component, e.g., a buffer, a register, etc. The latch 710 may be configured to maintain the settings of the light-emitting elements in the column associated with the latch. The latch 710 may be configured to change the settings of the light-emitting elements when signals indicate that newly-received display data should be latched, changing the data stored in the latch and the settings of the light-emitting elements, or when other signals indicate the latch should be reset.

The example display plane 106 may receive a system or display plane reset signal on a reset line. This reset signal may be transmitted to all of the latch mechanisms 710. The latch mechanisms may be configured to reset to a standard pre-defined setting, e.g., all light-emitting elements “off”, when the reset signal is received.

The example display plane 106 may also receive a write enable signal on a write enable line and a plane select signal on a plane select line. The plane select signal indicates that the data transmitted on the system chassis is intended for this particular display plane 106. The write enable signal may be used to clock the input of data and prevent race conditions. Writing display data to latches may be prevented when either the write enable or plane select signals are not present.

The example display plane may also receive a column address signal on a set of column address lines. This column address may be transmitted to an address decoder 706. In the example display plane, this decoder may be a standard 74LS138 3:8 decoder. The decoder 706 may have one output line associated with each of the latches 710 associated with display columns 108. The address decoder may decode the address data in order to determine a subset of the light-emitting elements in the plane the currently received data is intended to control. Based on the received address, the address decoder generates a signal on one of the output lines indicating the selected column. In the example display plane, only one of the columns will be selected at a given time. It will be appreciated that the example display plane could be modified to allow writing to multiple columns at the same time. It will also be appreciated that additional bits or more complex codes may be employed to address larger display planes with additional columns.

Control signals may be used to tell the latch when to change its settings, i.e., to read the current display data signal. The plane select, column select, and r/w enable select signals may all be anded together to generate a trigger signal for a latch 710 associated with a particular column. When the latch receives a trigger signal, it may change its state to reflect the currently received display data signal.

It will be appreciated that larger latches may be employed to address columns with a larger number of light-emitting elements. It will also be appreciated that latches might be shared for multiple columns. It will also be appreciated that the latching could be accomplished without using a discrete latch component, i.e., other components may also perform the latching of the data that represents the settings of the light-emitting elements. Additional buffering and clocking capabilities may also be provided, which would effect the operation of the latches.

In the illustrated example three-dimensional display, all display planes are identical. It will be appreciated that other embodiments could be constructed that include differently-sized and shaped planes, although appropriate alterations would need to be made in controller logic and physical design. It will also be appreciated that other methods of controlling the light-emitting elements may be provided. For example, light-emitting elements could have additional logic components that provide them with a unique address or identifier. When the state of the light-emitting element is to be changed, this address could be signaled by the display plane or system controller.

It will also be appreciated that no particular logic convention, e.g., high is true, need be used, as long as the selected convention is used consistently in the implementation of the three-dimensional display.

Modifications

In the preceding specification, the present invention has been described with reference to specific example embodiments thereof. It will, however, be evident that various modifications and changes may be made thereunto without departing from the broader spirit and scope of the present invention as set forth in the claims that follow. The specification and drawings are accordingly to be regarded in an illustrative rather than restrictive sense.

1. A three-dimensional display, comprising:
a plurality of light-emitting elements, said light-emitting elements arranged in a three-dimensional pattern, each light-emitting element having a plurality of display settings;
a plurality of display planes, each display plane comprising a mutually exclusive subset of the plurality of the light-emitting elements, the subsets of respective display planes being mutually exclusive; and
a controller, the controller configured to receive an external signal and to generate an internal signal for controlling the display settings of at least one of the plurality of light-emitting elements as a function of the external signal.

2. The three-dimensional display according to claim 1, wherein
the display planes are configured to allow the display settings of light-emitting elements in one of the plurality of display planes to be altered without altering the settings of light-emitting elements in other display planes.

3. The three-dimensional display of claim 1, further comprising:
a latch mechanism, the latch mechanism configured to receive the internal signal and to maintain the display setting of at least one of the light-emitting elements in at least one of the plurality of display planes until the internal signal indicates the display setting should be changed.

4. The three-dimensional display according to claim 1, wherein
the plurality of display planes are configured to allow individual display planes to be inserted and removed from the three-dimensional display.

5. The three-dimensional display according to claim 4, wherein
the plurality of display planes are configured to be interchangeable.

6. The three-dimensional display according to claim 1, wherein
at least one of the plurality of the display planes comprises a mounting element, and at least one of the plurality of light-emitting elements included in the at least one of the plurality of display planes is attached to the mounting element.

7. The three-dimensional display according to claim 6, wherein
the mounting element comprises a transparent rod.

8. The three-dimensional display according to claim 1, wherein
the plurality of display planes are positioned in parallel to each other.

9. The three-dimensional display according to claim 1, further comprising
storage element, the storage element configured to contain a sequence of predefined signals that when transmitted, causes the three-dimensional display to produce a sequence of predefined display images.

10. The three-dimensional display according to claim 1, wherein
the light-emitting elements are light-emitting diodes.

11. A three-dimensional display, comprising:
a plurality of light-emitting elements, said light-emitting elements arranged in a three-dimensional pattern, each light-emitting element having a plurality of display settings;
a plurality of display planes, each display plane comprising a mutually exclusive subset of the plurality of the light-emitting elements, the subsets of respective display planes being mutually exclusive, the plurality of display planes positioned in parallel to each other, the plurality of display planes configured to be interchangeable and to allow individual display planes to be inserted and removed from the three-dimensional display, the plurality of display planes also configured to allow the display settings of light-emitting elements in one of the plurality of display planes to be altered without altering the settings of light-emitting elements in other display planes, and at least one of the plurality of the display planes comprises a mounting element, the mounting element comprising a transparent plastic rod, and at least one of the plurality of light-emitting elements included in the at least one of the plurality of display planes is attached to the mounting element;
a controller, the controller configured to receive an external signal and to generate an internal signal for controlling the display settings of at least one of the plurality of light-emitting elements as a function of the external signal; and
a latch mechanism, the latch mechanism configured to receive the internal signal and to maintain the display setting of at least one of the light-emitting elements in at least one of the plurality of display planes until the internal signal indicates the display setting should be changed.
